(19) United States
(12) Patent Application Publication
(10) Pub. No.: US 2011/0175872 A1
(43) Pub. Date: Jul. 21, 2011

(54) DISPLAY DEVICE FOR CONVERTING BETWEEN BRIGHT AND DARK STATES AND METHOD THEREOF

(75) Inventors: Kai-Cheng CHUANG, Hsinchu City (TW); Tzu-Ming WANG, Hsinchu City (TW); Po-Wen HSIAO, Hsinchu City (TW); Gwo-Feng HWANG, Hsinchu City (TW)

(73) Assignee: PRIME VIEW INTERNATIONAL CO. LTD., Hsinchu City (TW)

(21) Appl. No.: 12/786,980

(22) Filed: May 25, 2010

(30) Foreign Application Priority Data
Jan. 20, 2010 (TW) 099101561

(51) Int. Cl. G09G 5/00

(52) U.S. Cl. 345/207

(57) ABSTRACT

The configurations and controlling methods of a display device are provided in the present invention. The proposed display device having an environmental brightness, a display content and a display background with a display brightness includes a light sensor sensing the environmental brightness and adjusting the display brightness according to the environmental brightness such that a reader could read the display content easily.

### FIELD OF THE INVENTION

The present invention relates to a display device for converting between a bright state and a dark state. More particularly, it relates to a display device having a light sensor for converting between a bright state and a dark state.

### BACKGROUND OF THE INVENTION

The existing bi-stable and reflective displays have no backlight, and there is an unclear feeling regarding the display content when an environment light source is insufficient. For the sake of improving the application effects of the bi-stable and reflective displays, a user could read the display content of the bi-stable and reflective display easily through sensing an external environmental brightness so as to determine whether or not to convert the display mode such that a brightness of a display screen is increased and both the clarity and comfort of reading are increased when the environment is dark.

Keeping the drawbacks of the prior arts in mind, and employing experiments and research full-heartily and persistently, the applicant finally conceived a display device for converting between a bright and a dark states and a method thereof.

### SUMMARY OF THE INVENTION

It is therefore an object of the present invention to provide a display device having a light sensor sensing an external environmental brightness and coupled to a control circuit for converting between a bright and a dark states such that a user could read the display content of the bi-stable and reflective display easily through sensing the external environmental brightness so as to determine whether or not to convert between a display mode of bright environment and a display mode of dark environment such that a brightness of a display screen is increased and both the clarity and comfort of reading are increased when the environment is dark.

According to the first aspect of the present invention, a display device converting between a bright and a dark states, having an environmental brightness, a display content having a first brightness and a display background with a second brightness comprises a light sensor sensing the environmental brightness, and a controller electrically connected to the light sensor, wherein the first brightness becomes smaller than the second brightness when the environmental brightness is not smaller than a predetermined value, and the first brightness becomes larger than the second brightness when the environmental brightness is smaller than the predetermined value such that a user could read the display content easily.

According to the second aspect of the present invention, a display having an environmental brightness and a display content with a first display brightness comprises a light sensor detecting the environmental brightness and adjusting the first display brightness according to the environmental brightness such that a user could read the display content easily.

According to the third aspect of the present invention, a display having an environmental brightness, a display content and a display background with a display brightness comprises a light sensor detecting the environmental brightness and adjusting the display brightness of the display background according to the environmental brightness such that a user could read the display content easily.

According to the fourth aspect of the present invention, a brightness adjusting method for a display having a display content and a display background comprises the steps of: determining a first brightness of the display content and a second brightness of the display background; sensing an environmental brightness of the display; and adjusting the first brightness and the second brightness so as to be in one of two states that the first brightness becomes smaller than the second brightness when the environmental brightness is not smaller than a predetermined value and the first brightness becomes larger than the second brightness when the environmental brightness is smaller than the predetermined value.

According to the fifth aspect of the present invention, a brightness adjusting method for a display having a display content comprises the steps of: determining a display brightness of the display content; sensing an environmental brightness of the display; and adjusting the display brightness according to the environmental brightness such that a user could read the display content easily.

According to the sixth aspect of the present invention, a brightness adjusting method for a display having a display content and a display background comprises the steps of: providing respectively display brightnesses of the display content and the display background; sensing an environmental brightness of the display; and adjusting the respective display brightnesses according to the environmental brightness such that a user could read the display content easily.

The present invention may best be understood through the following descriptions with reference to the accompanying drawings, in which:

### BRIEF DESCRIPTION OF THE DRAWINGS

FIG. 1 shows a schematic circuit diagram of a display screen of a display device for converting between a bright and a dark states under a bright environment status according to the preferred embodiment of the present invention;

FIG. 2 shows a schematic circuit diagram of a display screen of a display device for converting between a bright and a dark states under a dark environment status according to the preferred embodiment of the present invention;

FIG. 3 shows a block diagram of a display device for converting between a bright and a dark states according to the preferred embodiment of the present invention; and

FIG. 4 shows a flow chart of a brightness adjusting method for a display according to the preferred embodiment of the present invention.

### DETAILED DESCRIPTION OF THE PREFERRED EMBODIMENT

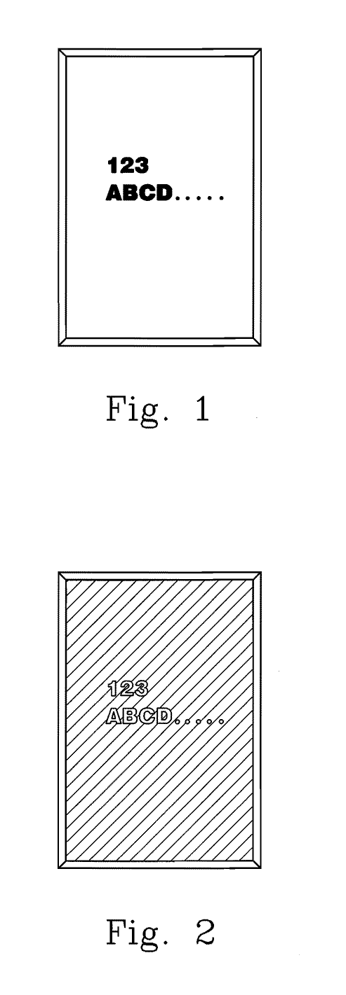

FIG. 1 is a schematic circuit diagram of a display screen of a display device for converting between a bright state and a dark state under a bright environment status according to the preferred embodiment of the present invention. When the environment is bright, e.g., when an environmental brightness is not smaller than (≧) a predetermined value, the display device for converting between the bright state and the dark state is under a bright environment status, and the schematic circuit diagram of the display screen shows that a brightness of a display content is larger (brighter) than a brightness of a display background, which means the texts on the display screen (i.e. the display content) are relatively dark (in black color) and the rest of the display screen (i.e. the display background) is relatively bright (in white color). FIG. 2 is a schematic circuit diagram of a display screen of a display device for converting between a bright state and a dark state under a dark environment status according to the preferred embodiment of the present invention. When the environment is dark, e.g., when the environmental brightness is smaller than the predetermined value, the display device for converting between the bright state and the dark state is under a dark environment status, and the schematic circuit diagram of the display screen shows that a brightness of the display content is smaller (darker) than a brightness of the display background, which means the texts on the display screen (i.e. the display content) are relatively bright (in white color) and the rest of the display screen (i.e. the display background) is relatively dark (the shaded area is in black color).

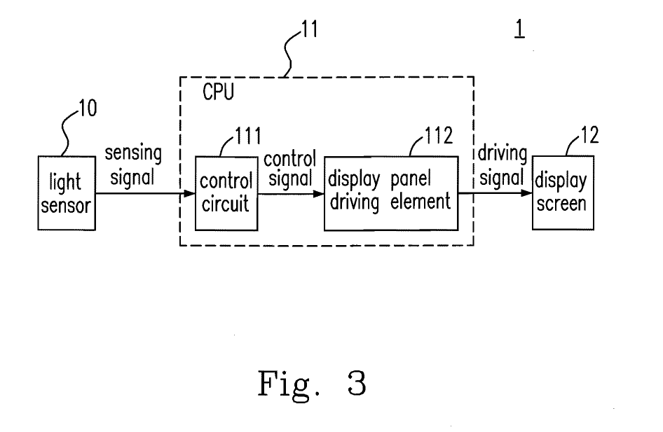

FIG. 3 is a block diagram of a display device for converting between a bright state and a dark state according to the preferred embodiment of the present invention, in which the display device 1 for converting between a bright state and a dark state has an environmental brightness (a surrounding brightness of the display device 1), a display content (e.g., Chinese/English texts or symbols) with a first brightness and a display background (e.g., the rest of the display screen 12 except for the display content) with a second brightness, and comprises a light sensor 10 sensing the environmental brightness, and a controlling circuit (e.g., a controller) 111 electrically connected to the light sensor 10, wherein the first brightness becomes smaller (darker) than the second brightness when the environmental brightness is not smaller than (≧) a predetermined value, and the first brightness becomes larger (brighter) than the second brightness when the environmental brightness is smaller than (<) the predetermined value such that a user could read the display content easily.

The display device 1 for converting between a bright state and a dark state further comprises a display panel driving element 112 electrically connected to the controller 111, wherein the controller 111 receives a sensing signal outputted from the light sensor 10 and outputs a control signal, and the display panel driving element 112 changes the first and the second brightnesses according to the control signal. The brightness of the display background (the second brightness) becomes larger than brightness of the display content (the first brightness) and a brightness of a first color of the display content becomes smaller (darker) than a brightness of a second color of the display background when the environmental brightness is not smaller than (≧) a predetermined brightness value, and the second brightness becomes smaller (darker) than the first brightness and the brightness of the first color becomes larger (brighter) than the brightness of the second color when the environmental brightness is smaller than a predetermined brightness value. The first color is black and the second color is white when the brightness of the first color is smaller (darker) than the brightness of the second color, and the first color is white and the second color is black when the brightness of the first color is larger (brighter) than the brightness of the second color.

The display device 1 for converting between a bright state and a dark state is a display, e.g., it is a bi-stable and reflective display, wherein the display content displays a text/texts being a first portion of the display screen 12, and the display background is a second portion of the display screen 12. As aforementioned, the display device 1 for converting between a bright state and a dark state comprises a light sensor 10, a controller 111, a display panel driving element 112 and a display screen 12, wherein the controller 111 is coupled to the light sensor 10, and the controller 111 and the display panel driving element 112 are both configured in a central processing unit (CPU) 11, the brightness of the display background (the second display brightness) becomes larger (brighter) than brightness of the display content (the first display brightness) and a brightness of a first color of the display content becomes smaller (darker) than a brightness of a second color of the display background when the environmental brightness is not smaller than (≧) a predetermined brightness value, and the second display brightness becomes smaller (darker) than the first display brightness and the brightness of the first color becomes larger (brighter) than the brightness of the second color when the environmental brightness is smaller than a predetermined brightness value.

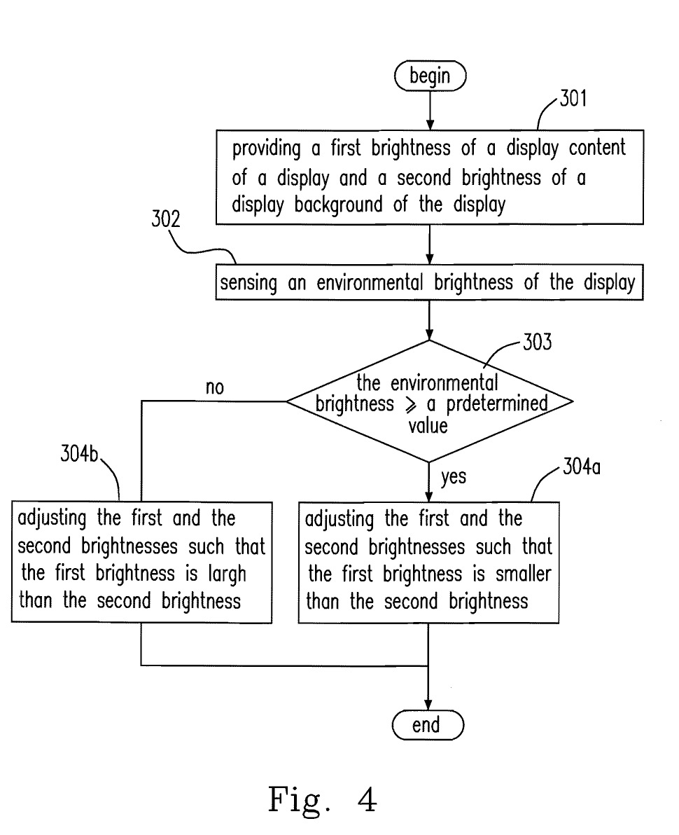

The present invention also provides a brightness adjusting method for a display (the display device for converting between a bright state and a dark state), and FIG. 4 is a flow chart of a brightness adjusting method for a display according to the preferred embodiment of the present invention. The method comprises the steps of: determining (providing) a first brightness of the display content and a second brightness of the display background (step 301); sensing an environmental brightness of the display (step 302); and adjusting the first brightness and the second brightness so as to be in one of two states that the first brightness becomes smaller than the second brightness (step 304a) when the environmental brightness is not smaller than a predetermined value (step 303) and the first brightness becomes larger than the second brightness (step 304b) when the environmental brightness is smaller than the predetermined value (step 303).

The above-mentioned method could be properly simplified, e.g., a brightness adjusting method for a display having a display content comprises the steps of: determining (providing) a display brightness of the display content; sensing an environmental brightness of the display; and adjusting the display brightness according to the environmental brightness such that a user could read the display content easily.

The above-mentioned method could be simplified differently, e.g., a brightness adjusting method for a display having a display content and a display background comprises the steps of: providing respectively display brightnesses of the display content and the display background; sensing an environmental brightness of the display; and adjusting the respective display brightnesses according to the environmental brightness such that a user could read the display content easily.

According to the aforementioned descriptions, the present invention provides a display device having a light sensor sensing an external environmental brightness and coupled to a control circuit for converting between a bright and a dark states such that a user could read the display content of the bi-stable and reflective display easily through sensing the external environmental brightness so as to determine whether or not to convert between a display mode of bright environment and a display mode of dark environment such that a brightness of a display screen is increased and both the clarity and comfort of reading are increased when the environment is dark so as to possess the non-obviousness and the novelty.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A display device converting between a bright and a dark states, having an environmental brightness, a display content with a first brightness and a display background with a second brightness, and comprising:
a light sensor sensing the environmental brightness; and
a controller electrically connected to the light sensor,
wherein the first brightness becomes smaller than the second brightness when the environmental brightness is not smaller than a predetermined value, and the first brightness becomes larger than the second brightness when the environmental brightness is smaller than the predetermined value such that a user could read the display content easily.

2. A device according to claim 1 further comprising a display panel driving element electrically connected to the controller, wherein the controller receives a sensing signal outputted from the light sensor and outputs a control signal, and the display panel driving element changes the first and the second brightnesses according to the control signal.

3. A device according to claim 1, wherein the display content has a first color and the display background has a second color, the second brightness becomes larger than the first brightness and a brightness of the first color becomes smaller than a brightness of the second color when the environmental brightness is not smaller than a predetermined brightness value, and the second brightness becomes smaller than the first brightness and the brightness of the first color becomes larger than the brightness of the second color when the environmental brightness is smaller than a predetermined brightness value.

4. A device according to claim 3, wherein the first color is black and the second color is white when the brightness of the first color is smaller than the brightness of the second color, and the first color is white and the second color is black when the brightness of the first color is larger than the brightness of the second color.

5. A device according to claim 1 being a bi-stable and reflective display and further comprising a display screen having a first portion and a second portion, wherein the display content displays a text being the first portion, and the display background is the second portion.

6. A display having an environmental brightness and a display content with a first display brightness, comprising a light sensor detecting the environmental brightness and adjusting the first display brightness according to the environmental brightness such that a user could read the display content easily.

7. A display according to claim 6 further comprising a controller and a display background having a second display brightness, wherein the controller is coupled to the light sensor and is configured in a central processing unit (CPU), the second display brightness is not smaller than the first display brightness and a brightness of a first color of the display content becomes smaller than a brightness of a second color of the display background when the environmental brightness is not smaller than a predetermined brightness value, and the second display brightness is smaller than the first display brightness and the brightness of the first color of the display content becomes larger than the brightness of the second color of the display background when the environmental brightness is smaller than a predetermined brightness value.

8. A brightness adjusting method for a display having a display content and a display background, comprising the steps of:
determining a first brightness of the display content and a second brightness of the display background;
sensing an environmental brightness of the display; and
adjusting the first brightness and the second brightness so as to be in one of two states that the first brightness becomes smaller than the second brightness when the environmental brightness is not smaller than a predetermined value and the first brightness becomes larger than the second brightness when the environmental brightness is smaller than the predetermined value.

9. A method according to claim 8, wherein the display comprises a light sensor sensing the environmental brightness, the display is a bi-stable and reflective display, and the step of adjusting the first brightness further comprises the following steps:
causing a brightness of a first color of the display content to become smaller than a brightness of a second color of the display background when the adjusted second brightness is not smaller than the adjusted first brightness; and
causing the brightness of the first color to become larger than the brightness of the second color when the adjusted second brightness is smaller than the adjusted first brightness.

10. A method according to claim 8, wherein the first brightness is a brightness of the display content, the second brightness is a brightness of the display background, and the step of adjusting the first brightness further comprises a step of: adjusting a brightness of a first color of the display content and a brightness of a second color of the display background so as to be in one of two states that the brightness of the first color becomes smaller than the brightness of the second color when the adjusted second brightness is not smaller than the adjusted first brightness and the brightness of the first color becomes larger than the brightness of the second color when the adjusted second brightness is smaller than the adjusted first brightness.
